(19) United States
(12) Patent Application Publication
(10) Pub. No.: US 2014/0140562 A1
(43) Pub. Date: May 22, 2014

(54) EARPHONE WINDING STRUCTURE

(71) Applicant: JETVOX ACOUSTIC CORP., Taoyuan County (TW)

(72) Inventor: To-Teng HUANG, Taoyuan County (TW)

(73) Assignee: JETVOX ACOUSTIC CORP., Taoyuan County (TW)

(21) Appl. No.: 13/743,910

(22) Filed: Jan. 17, 2013

(30) Foreign Application Priority Data
Nov. 21, 2012 (TW) 101222582

(51) Int. Cl. H04R 1/10

(52) U.S. Cl. CPC H04R 1/1033
USPC 381/378; 381/383

(57) ABSTRACT

An earphone winding structure includes: a first cap, a second cap, a connection portion, a signal line and a winding component. The winding component is located at the first cap, and includes a body, a shaft and a housing. The housing is connected to the shaft and bent into an opening state or a closing state with the shaft as the center. When the housing is bent into the opening state, the shaft is exposed and is used for winding the signal line, and when the housing is bent into the closing state, the housing covers the body and the signal line.

### CROSS-REFERENCES TO RELATED APPLICATIONS

This non-provisional application claims priority under 35 U.S.C. §119(a) on Patent Application No. 101222582 filed in Taiwan, R.O.C. on Nov. 21, 2012, the entire contents of which are hereby incorporated by reference.

### BACKGROUND OF THE INVENTION

1. Technical Field

The present invention relates to an earphone structure, and more particularly to an earphone winding structure.

2. Related Art

Currently, two earphone caps of a headphone are physically connected through a plastic head band, and an ordinary signal transmission line is electrically connected between the two earphone caps.

The ordinary signal transmission line is electrically connected to one of the earphone caps, and is used in a situation that only one earphone body is connected with a signal input line located at a side opposite to the head band, so that the earphone is convenient to wear.

However, the signal transmission line is embedded in the plastic head band, so that not only is the wire-embedding processing time-consuming, but the design complexity is also increased for the wiring procedure based on appearance requirements. Additionally, the signal transmission line cannot be wound on the earphone cap for accommodation, so the signal transmission line of the conventional earphone is generally exposed, and there is no space or structure design for accommodating cables.

Thus, under the situation that the earphone appearance is considered and the structure thereof conforms to functional demands, how to further improve the structure in the originally fixed earphone model is a topic studied in the field.

### SUMMARY

In view of the above problem, the present invention provides an earphone winding structure, so as to solve the problem in the prior art that cables cannot be accommodated.

An embodiment of the present invention provides an earphone winding structure including: a first cap, a second cap, a connection portion, a signal line and a winding component. The winding component is located at the first cap, and includes a body, a shaft and a housing. The housing is connected to the shaft and bent into an opening state or a closing state with the shaft as the center. When the housing is bent into the opening state, the shaft is exposed and is used for winding the signal line, and when the housing is bent into the closing state, the housing covers the body and the signal line.

According to the present invention, the housing of the winding component is connected to the shaft and is bent with the shaft as the center. When the housing is opened, it is convenient to wind the signal line for accommodation, and when the housing is elastically restored and covers the body, an aesthetic appearance of the earphone cap is formed. Furthermore, an audio signal and a grounding signal are transmitted through a plurality of conducting strips provided in the connection portion, and the conventional manner of pulling and threading the signal line to the left and right caps for use is changed. Additionally, through the structure arrangement of the sleeving component, the connection portion and the signal line can be welded on the sleeving component, and meanwhile the first cap may be rotated leftward or rightward with the sleeving component as the pivot center, so as to solve the problem in the prior art that cables cannot be accommodated.

### BRIEF DESCRIPTION OF THE DRAWINGS

The present invention will become more fully understood from the detailed description given herein below for illustration only, and thus not limitative of the present invention, wherein:

FIG. 1 is a schematic outside view of a first embodiment of the present invention;

FIG. 2 is a schematic partially exploded view of the first embodiment of the present invention;

FIG. 3 is a schematic partial outside view of the first embodiment of the present invention;

FIG. 4 is a schematic partial outside view at another viewing angle in FIG. 3;

FIG. 5 is a schematic enlarged view of the first embodiment of the present invention in winding;

FIG. 6 is a schematic enlarged view of the first embodiment of the present invention after winding; and

FIG. 7 is a schematic partial view of the first embodiment of the present invention in use.

### DETAILED DESCRIPTION

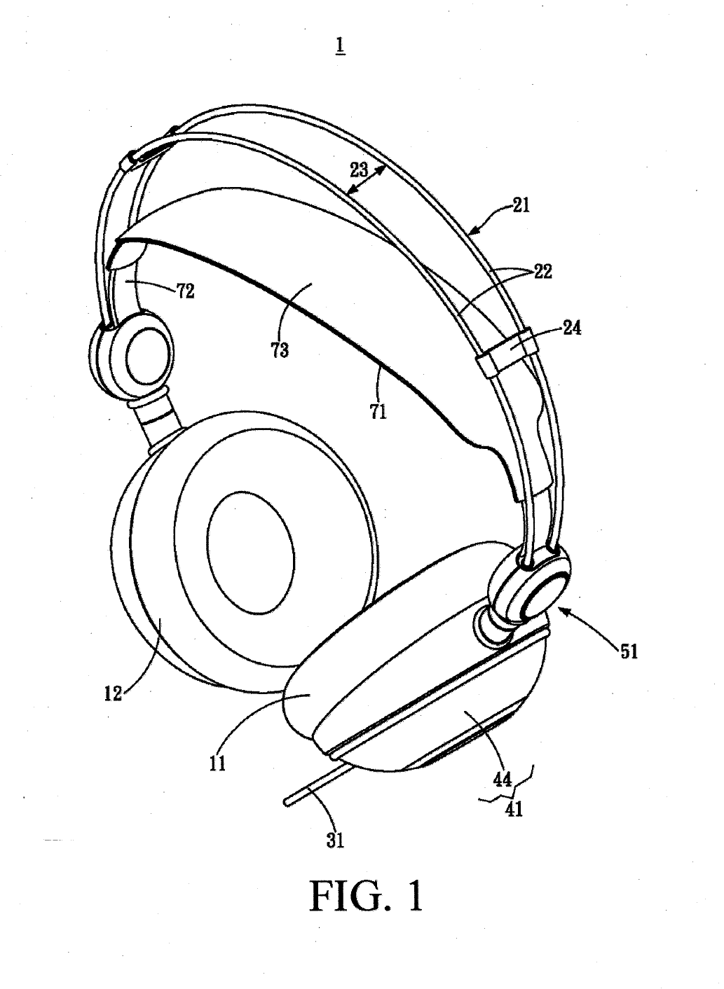

FIG. 1 is a schematic view of an earphone according to a first embodiment of the present invention.

An earphone winding structure 1 according to the embodiment of the present invention is a headphone, and includes a first cap 11, a second cap 12, a connection portion 21, a signal line 31 and a winding component 41.

As shown in FIG. 1, the first cap 11 and the second cap 12 are spherical caps, and match the size of an ear so as to wrap the ear. Here, the first cap 11 and the second cap 12 are a right sound track audio cap and a left sound track audio cap respectively, but this embodiment is not limited thereto. Additionally, the first cap 11 and the second cap 12 are provided with a single-body structure of an ordinary earphone speaker (not shown).

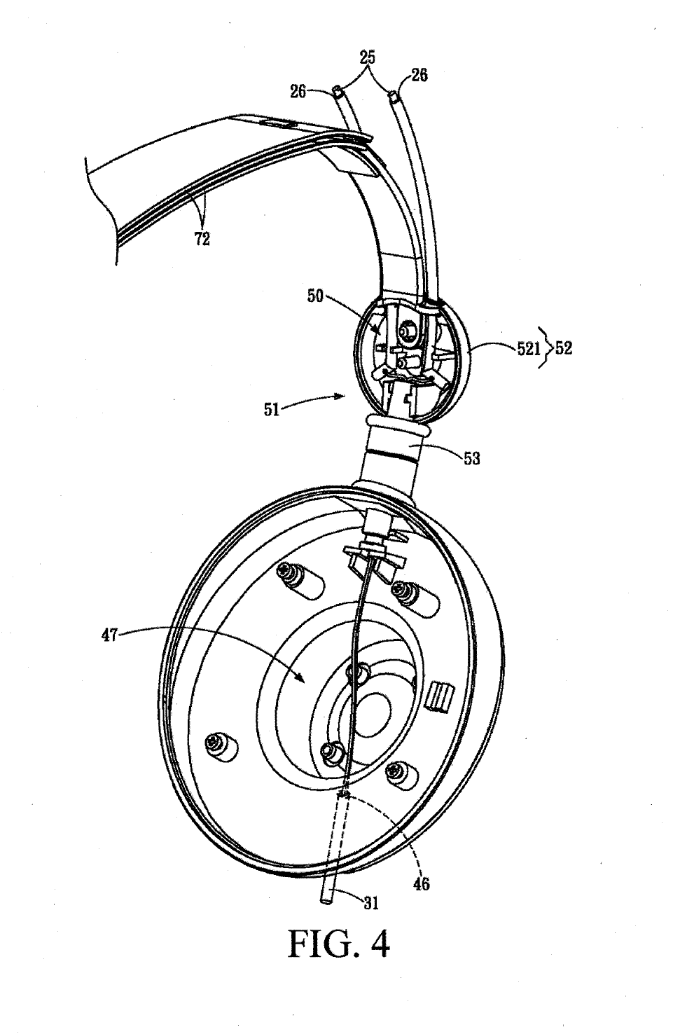

As shown in FIG. 1, the connection portion 21 is connected to the first cap 11 and the second cap 12, and the connection portion 21 is formed of a plurality of conducting strips 22. The plurality of conducting strips 22 forms a structural body of a curved rod. The conducting strip 22 is formed of a conductor 25 and an insulating layer 26 (as shown in FIG. 4). The conductor 25 is made of a metal material (such as copper), and used for transmitting signals. The insulating layer 26 is electroplated on an outer surface of the conductor 25, and is made of a metal material (such as nickel or stainless steel).

In this embodiment, the plurality of conducting strips 22 transmits an audio signal and a grounding signal, and the audio signal is a left sound track audio signal, but the present invention is not limited thereto. An interval 23 existed between two conducting strips 22, a plurality of holders 24 is disposed in the interval 23, and two ends of the holder 24 are respectively connected to the two conducting strips 22, so that the plurality of conducting strips 22 is independent from each other, and a certain interval is maintained between the two conducting strips 22. When transmitting the audio signal, one conducting strip 22 may not move too close to the other conducting strip 22 to cause signal interference.

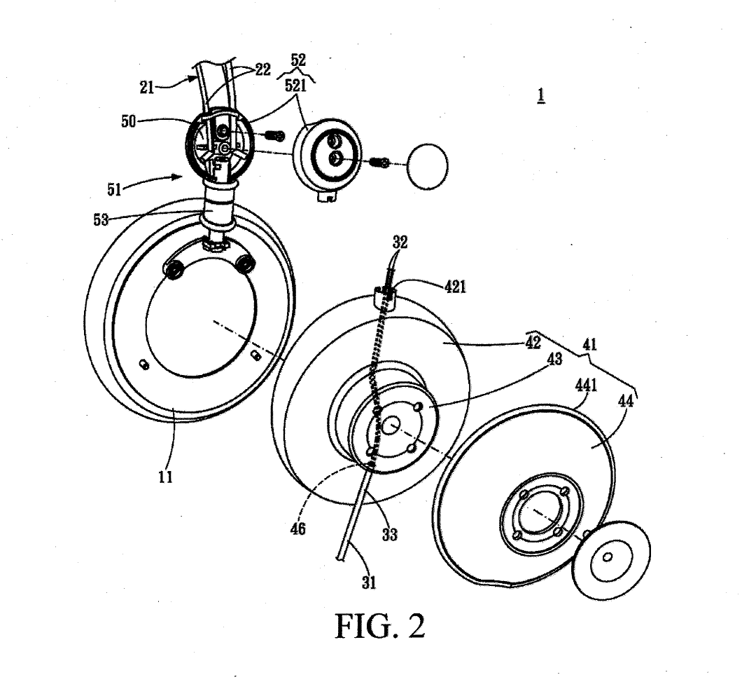

FIG. 2 is a schematic partially exploded view of the first cap 11 according to the first embodiment of the present invention.

As shown in FIG. 2, one end of the signal line 31 is connected to the first cap 11, and the other end of the signal line 31 is plugged in an earphone hole (not shown), of an ordinary electronic apparatus (such as a mobile phone or an mp3 player). The signal line 31 is formed of a plurality of core lines 32 and an insulating sheath 33, and is used for transmitting an audio signal and a grounding signal.

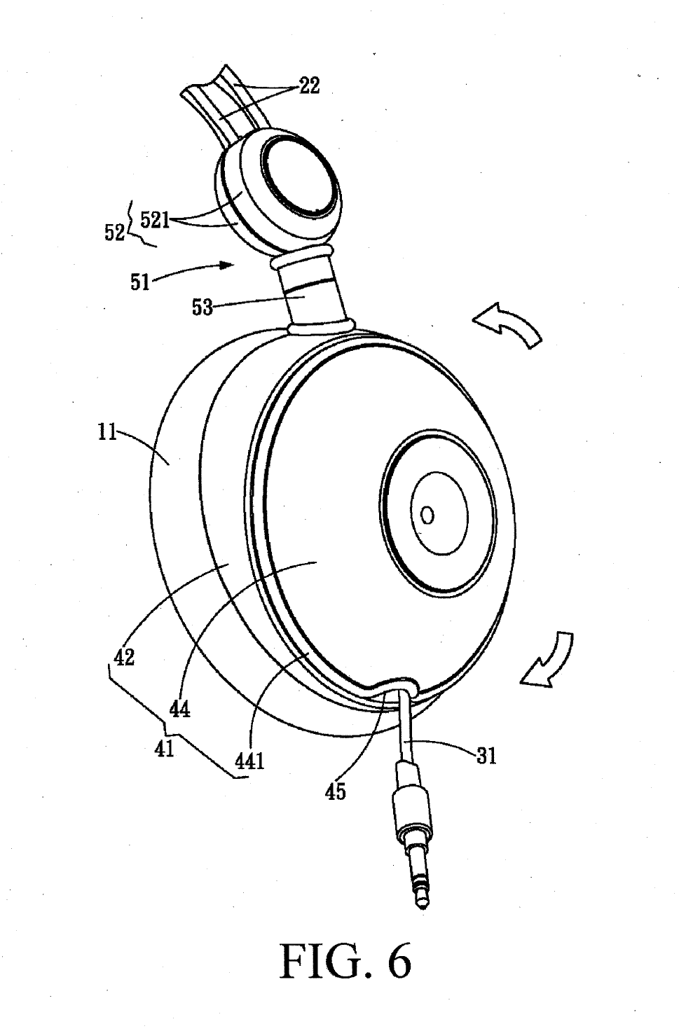

As shown in FIG. 2, the winding component 41 is located on the first cap 11, and is formed of a body 42, a shaft 43 and a housing 44. The body 42 is a disk-shaped accommodating body (Please refer to FIG. 4 together), the shaft 43 is located on a side of the body 42 and is integrally formed with the body 42, and the shaft 43 is cylindrical and protrudes from the side of the body 42. Furthermore, the housing 44 is connected to the shaft 43, the cross-section of the housing 44 is semi-arc-shaped, and the housing 44 is a soft cushion made of a soft material (such as silica gel or plastic), so as to provide characteristics of being elastic and bendable. The housing 44 includes a wire outlet hole 45 located at an outer ring side of the housing 44 (as shown in FIG. 6). In this embodiment, the winding component 41 further includes a wire inlet hole 46 and a threading groove 47 (as shown in

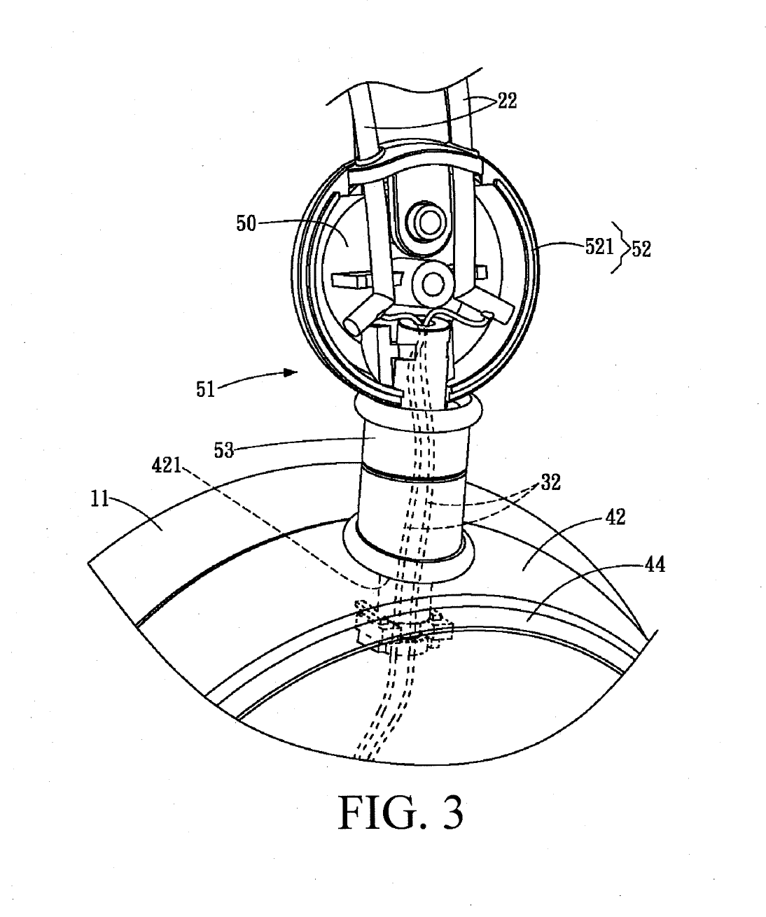

FIG. 4). The wire inlet hole 46 is located at the shaft 43, and the threading groove 47 is located at the body 42 and communicated with the shaft 43, namely, after being threaded into the wire inlet hole 46, the signal line 31 may enter the threading groove 47, and then the signal line 31 is pulled out from a hole 421 additionally opened on the body 32, so that the signal line 31 and the connection portion 21 are welded (as shown in FIG. 3 and FIG. 4).

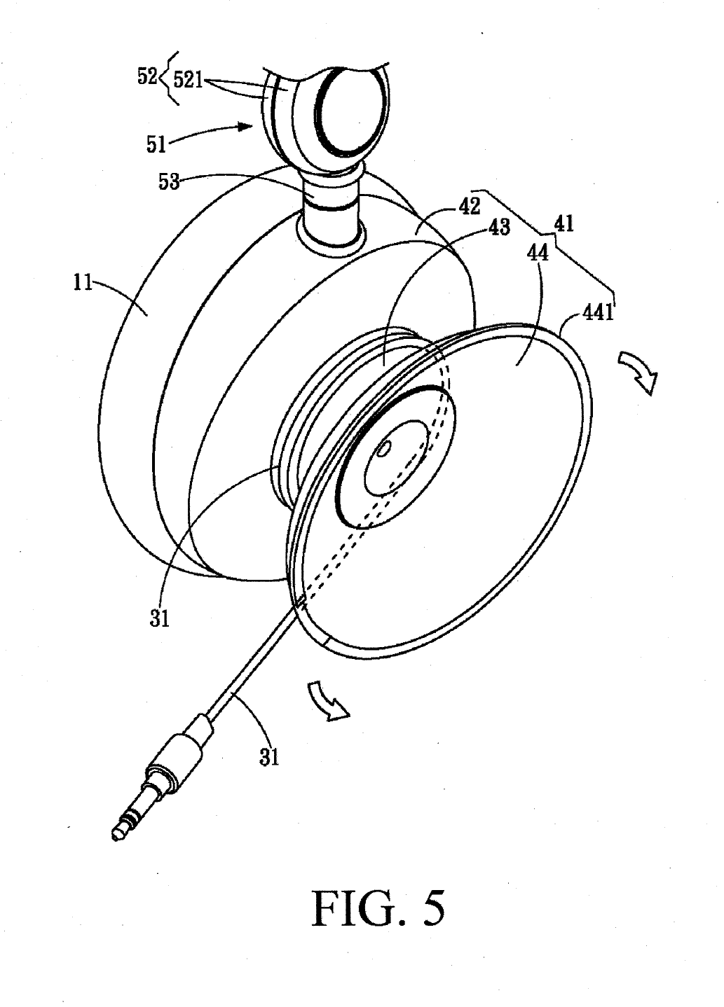

Please refer to FIG. 5 and FIG. 6, in which embodiment the central position (namely, the arched top end area), of the housing 44 is combined on the shaft 43, and therefore, when a user pushes an outside end of the housing 44, the outside end 441 of the housing 44 is bent into an opening state or a closing state with the shaft 43 as the center. When the housing 44 is bent into the opening state, the shaft 43 is exposed and is used for winding the signal line 31 to be accommodated. When only a part of the cables and the joint of the signal line 31 are left after winding, the housing 44 may be pushed, so that the housing 44 is restored to the closing state due to its elasticity (namely, the housing 44 covers the body 42), and at this time, a part of the cables and the joint of the signal line 31 are exposed out of the wire outlet hole 45.

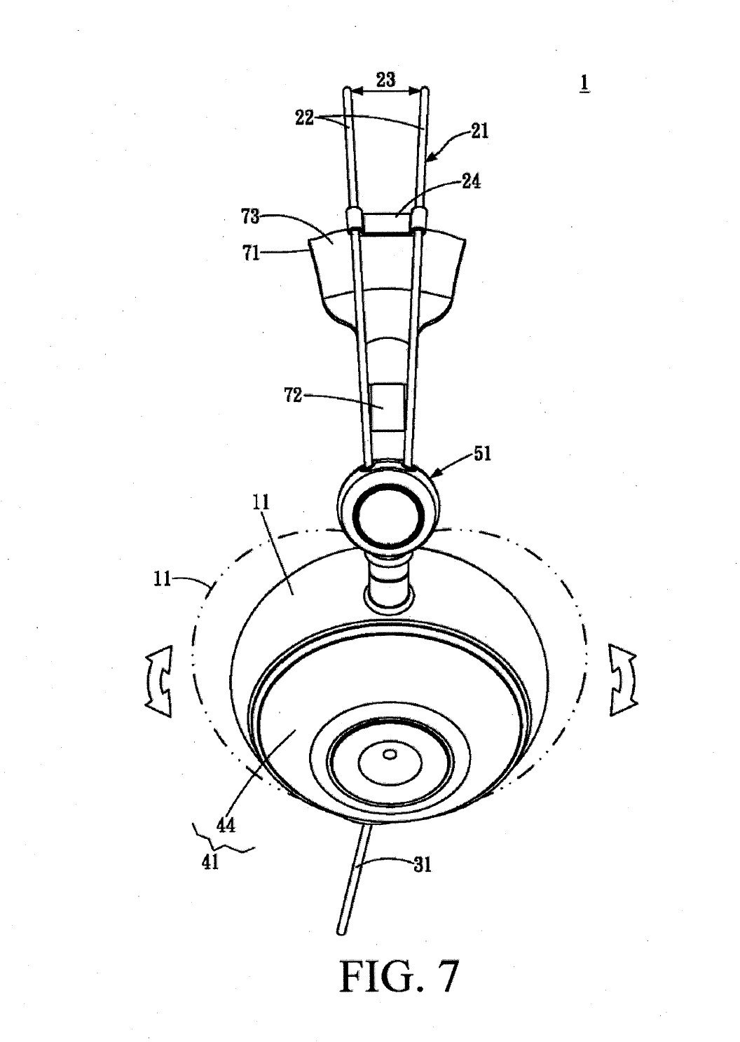

As shown in FIG. 2, in this embodiment, the earphone winding structure 1 includes a sleeving component 51, one end of the connection portion 21 is connected to the sleeving component 51, and the signal line 31 is threaded into the sleeving component 51 and connected to the connection portion 21. The sleeving component 51 is formed of a cover 52 and a pipe 53. The cover 52 is formed of two semi-spherical housings 521, and a welding space 50 is provided inside the housing 521, namely, an area capable of accommodating a connection part of the connection portion 21 and the signal line 31 is provided, and therefore, the connection part of the connection portion 21 and the signal line 31 is welded in the welding space 50. The pipe 53 is a hollow cylinder, namely, the signal line 31 runs through the pipe 53 and is located in the welding space 50 of the cover 52. In this embodiment, one end of the pipe 53 is pivoted to the cover 52, and the other end of the pipe 53 is pivoted to the body 42 of the winding component 41. The first cap 11 is rotated leftward or rightward with the pipe 53 as the center (as shown in FIG. 7), so as to be adjusted into an appropriate wearing angle.

As shown in FIG. 2, in this embodiment, the earphone winding structure 1 further includes a head band 71, and the head band 71 forms a curved and elastically stretchable structure. The head band 71 is located inside the connection portion 21 (namely, at a position close to the head), and is connected to the first cap 11 and the second cap 12. The head band 71 is formed of a plurality of extending sheets 72 and a soft cushion 73 (as shown in FIG. 4). The plurality of extending sheets 72 includes a plurality of hooks (not shown), so that the plurality of extending sheets 72 can be lapped with each other at different positions to change the length of the head band, namely, to provide the effect that two extending sheets 72 may be limited by each other and not separated during stretching. The two extending sheets 72 may be stretched away from each other, or, the two extending sheets 72 may be stretched toward each other and overlapped together, so that the distance between the first cap 11 and the second cap 12 is enlarged or narrowed.

In conclusion, the housing of the winding component is connected to the shaft and is bent with the shaft as the center. When the housing is opened, it is convenient to wind the signal line for accommodation, and when the housing is elastically restored and covers the body, an aesthetic appearance of the earphone cap is formed. Furthermore, an audio signal and a grounding signal are transmitted through a plurality of conducting strips, and the conventional manner of pulling and threading the signal line to the left and right caps for use is changed. Additionally, through the structure arrangement of the sleeving component, the connection portion and the signal line can be welded on the sleeving component, and meanwhile the first cap may be rotated leftward or rightward with the sleeving component as the pivot center.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An earphone winding structure, comprising:
a first cap;
a second cap;
a connection portion, connected to the first cap and the second cap;
a signal line, having one end connected to the first cap and the other end plugged in an earphone hole of an electronic apparatus; and
a winding component, located at the first cap, and comprising:
a body;
a shaft, located at the body; and
a housing, connected to the shaft and bent into an opening state or a closing state with the shaft as the center, wherein when the housing is bent into the opening state, the shaft is exposed and is used for winding the signal line, and when the housing is bent into the closing state, the housing covers the body and the signal line.

2. The earphone winding structure according to claim 1, wherein the connection portion comprises a plurality of conducting strips, an interval exists between the conducting strips, and the conducting strips are independent from each other and transmit an audio signal and a grounding signal.

3. The earphone winding structure according to claim 2, wherein the conducting strip comprises a conductor and an insulating layer, and the insulating layer is located on an outer surface of the conductor.

4. The earphone winding structure according to claim 2, wherein a plurality of holders connected to the conducting strips is disposed in the interval.

5. The earphone winding structure according to claim 1, further comprising a sleeving component, wherein one end of the connection portion is connected to the sleeving component, and the signal line is threaded into the sleeving component and connected to the connection portion.

6. The earphone winding structure according to claim 5, wherein the sleeving component comprises:
a cover, comprising a welding space for accommodating a connection part of the connection portion and the signal line; and
a pipe, having one end pivoted to the cover and the other end pivoted to the body of the winding component.

7. The earphone winding structure according to claim 1, further comprising a head band, located inside the connection portion and connected to the first cap and the second cap.

8. The earphone winding structure according to claim 7, wherein the head band comprises a plurality of extending sheets, and the extending sheets are lapped at different positions so as to change the length of the head band.

9. The earphone winding structure according to claim 1, wherein the winding component further comprises:
a wire inlet hole, located at the shaft; and
a threading groove, located at the body and communicated with the shaft, wherein the signal line is threaded into the wire inlet hole and the threading groove and connected to the connection portion.

10. The earphone winding structure according to claim 1, wherein the housing of the winding component comprises a wire outlet hole located at an outer ring side of the housing, and when the housing is bent into the closing state, the signal line is exposed out of the wire outlet hole.
